(19) United States
(12) Patent Application Publication
(10) Pub. No.: US 2026/0188721 A1
(43) Pub. Date: Jul. 2, 2026

(54) METHOD FOR MANUFACTURING BATTERY MODULE

(71) Applicant: SUBARU CORPORATION, Tokyo (JP)

(72) Inventor: Masazumi MIYAGO, Tokyo (JP)

(21) Appl. No.: 19/421,923

(22) Filed: Dec. 16, 2025

(30) Foreign Application Priority Data
Dec. 27, 2024 (JP) 2024-232096

(51) Int. Cl. H01M 10/04; H01M 10/643; H01M 10/6555; H01M 50/213

(52) U.S. Cl. CPC H01M 10/0481; H01M 10/643; H01M 10/6555; H01M 50/213

(57) ABSTRACT

A method for manufacturing a battery module including a stacked body including units stacked in a third direction and each including a first cell group and a second cell group in which cells extending in a first direction are arranged in a second direction, and a temperature control plate; and a side plate, includes: bonding a side surface of the stacked body and the side plate; conveying a semi-finished product including the stacked body and the side plate to a work place while pressing the side plate toward a side of the stacked body by a first pressing member; pressing the side plate of the semi-finished product toward a side of the stacked body by a second pressing member; and releasing the pressing of the side plate by the first pressing member in a state where the pressing of the side plate by the second pressing member is maintained.

### CROSS-REFERENCE TO RELATED APPLICATIONS

The present application claims priority from Japanese Patent Application No. 2024-232096 filed on Dec. 27, 2024, the entire contents of which are hereby incorporated by reference.

### BACKGROUND

The present disclosure relates to a method for manufacturing a battery module.

Conventionally, there has been known an electric vehicle that can travel by a motor using electric power stored in a battery module in a battery pack. For example, Japanese Unexamined Patent Application Publication (Translation of PCT Application) (JP-T) 2023-502274 discloses a battery pack that is disposed at the center of a lower portion of a vehicle body of an electric vehicle and includes battery modules. The battery module of JP-T No. 2023-502274 includes a stacked body in which units including a first cell group, a second cell group, and a temperature control plate disposed between the first cell group and the second cell group are stacked.

### SUMMARY

An aspect of the disclosure provides a method for manufacturing a battery module. The battery module includes a stacked body and a side plate. The stacked body includes units stacked in a third direction. The units each include a first cell group and a second cell group, and a temperature control plate. In the first cell group and the second cell group, cells extending in a first direction are arranged in a second direction orthogonal to the first direction. The temperature control plate is disposed between the first cell group and the second cell group and extends in the second direction. The side plate is bonded to a side surface of the stacked body in the third direction. The method includes: bonding the stacked body and the side plate, conveying a semi-finished product; pressing the side plate; and releasing pressing of the side plate. The side surface of the stacked body and the side plate are bonded via an adhesive. The semi-finished product including the stacked body and the side plate is conveyed to a work place of a predetermined subsequent step while pressing the side plate toward a side of the stacked body by a first pressing member. The side plate of the semi-finished product conveyed to the work place is pressed toward a side of the stacked body by a second pressing member disposed in the work place. The pressing of the side plate by the first pressing member is released in a state where pressing of the side plate by the second pressing member is maintained.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a cross-sectional view illustrating an example of a configuration of a battery module according to an embodiment of the disclosure;

FIG. 2 is a schematic view illustrating a configuration of a stacked body;

FIG. 3 is a flowchart for describing a method for manufacturing the battery module according to the embodiment;

FIG. 4 is a flowchart for describing a flow of an assembling step;

FIG. 5 is a flowchart for describing a flow of a conveyance step;

FIG. 6 is a schematic view illustrating an example of the conveyance step;

FIG. 7 is a side view of the target semi-finished product as viewed from the side in the conveyance step;

FIG. 8 is a schematic view illustrating an example of a state after conveyance in the conveyance step; and

FIG. 9 is a side view of the target semi-finished product as viewed from the side after the conveyance in the conveyance step.

### DETAILED DESCRIPTION

In a manufacturing process of a battery module, an assembling step may be performed to bond a side plate, an upper cover, a bus bar module, and a lower cover to a stacked body via an adhesive. In the assembling step, for example, after the assembling of the side plate and the assembling of the upper cover are performed, the semi-finished product may be conveyed to a work place where the bus bar module is assembled. Here, it takes a predetermined time according to the type and characteristics of the adhesive until the adhesive for bonding the side plate and the like is dried, that is, until the bonding is completed. Therefore, for example, when the semi-finished product is conveyed to a work place where the bus bar module is assembled before the adhesive for bonding the side plate is dried, the side plate may be peeled off from the stacked body. On the other hand, for example, when the semi-finished product is conveyed to the work place where the bus bar module is assembled after the completion of the bonding of the side plate, the manufacturing time becomes unnecessarily long.

It is desirable to provide a method for manufacturing a battery module capable of appropriately bonding a side plate to a stacked body.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### Battery Module

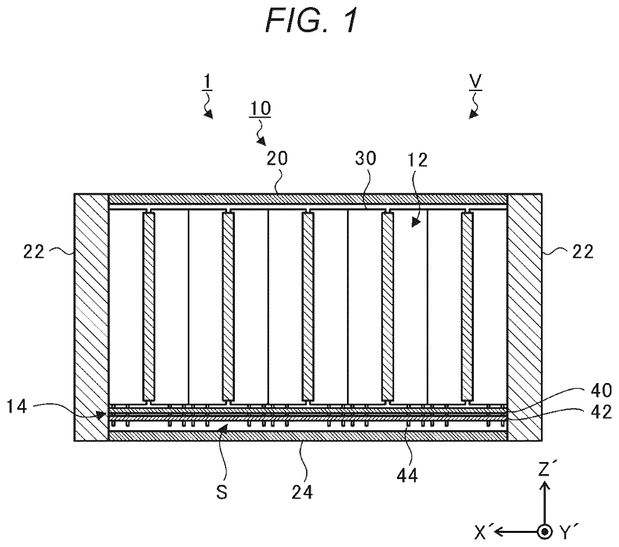

FIG. 1 is a cross-sectional view illustrating an example of a configuration of a battery module 1 according to the embodiment. In FIG. 1, an X′ direction indicates a width direction of the battery module 1, a Y′ direction indicates a length direction of the battery module 1, and a Z′ direction indicates a height direction of the battery module 1.

The battery module 1 may be mounted on a vehicle V such as an electric vehicle including a motor generator as a drive source. Note that the vehicle V is not limited to an electric vehicle, and may be a hybrid electric vehicle including a motor generator and an engine as a drive source. In addition, the battery module 1 is not limited to be mounted on the vehicle V, and may be mounted on various apparatuses.

The battery module 1 includes a case 10, a stacked body 12, and a bus bar module 14.

The case 10 forms a housing space S therein. The case 10 includes an upper cover 20, a side plate 22, and a lower cover 24. A space surrounded by the upper cover 20, the side plate 22, and the lower cover 24 is a housing space S. The stacked body 12 and the bus bar module 14 are accommodated in the housing space S inside the case 10. The stacked body 12 is positioned on an upper side in the Z′ direction with respect to the bus bar module 14.

The upper cover 20 is disposed on an upper side in the Z′ direction with respect to the stacked body 12. The upper cover 20 has a rectangular flat plate shape. The upper cover 20 covers the upper side of the stacked body 12 in the Z′ direction.

The lower cover 24 is disposed below the bus bar module 14 in the Z′ direction. The lower cover 24 has a rectangular flat plate shape. The lower cover 24 covers the lower side of the bus bar module 14 in the Z′ direction.

A pair of side plates 22 is disposed on both sides in the X′ direction with respect to the stacked body 12 and the bus bar module 14. The side plate 22 has a rectangular flat plate shape. The side plate 22 covers both sides of the stacked body 12 and the bus bar module 14 in the X′ direction. The upper cover 20 is coupled to an upper end of the side plate 22 in the Z′ direction. The lower cover 24 is coupled to a lower end of the side plate 22 in the Z′ direction.

The stacked body 12 includes cells 30. The cells 30 are single batteries of chargeable/dischargeable secondary batteries such as lithium ion batteries. The cells 30 are each assumed to be formed in a columnar shape, but are not limited to a columnar shape, and may be formed in various shapes such as a prismatic shape and an elliptical columnar shape. Each of the cells is disposed upright so as to extend in the height direction (Z′ direction in FIG. 1) of the battery module 1. The cell 30 has positive and negative electrodes. The stacked body 12 will be described in detail later.

The bus bar module 14 includes a bus bar plate 40, bus bars 42, and wires 44. The bus bar plate 40 holds the bus bars 42. The bus bar 42 is formed of a conductive material in a sheet shape or a plate shape. Each of the wires 44 electrically couples one of the electrodes of one of the cells 30 and one of the bus bars 42. The bus bar 42 electrically couples the electrodes of the cells 30 via the wire 44. The cells 30 are coupled in parallel and in series via the wires 44 and the bus bars 42.

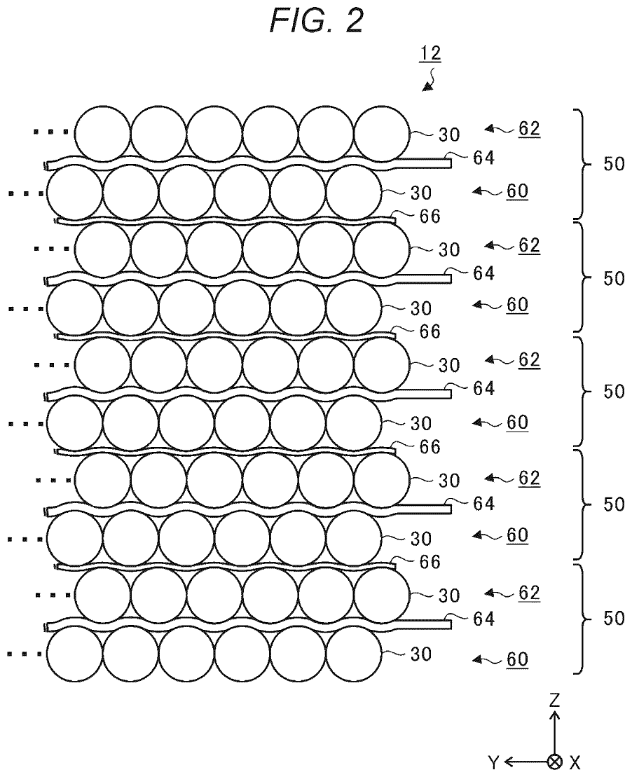

FIG. 2 is a schematic view illustrating a configuration of the stacked body 12. FIG. 2 illustrates a state in which the stacked body 12 illustrated in FIG. 1 is viewed from the Z′ direction in FIG. 1. In FIG. 2, an X direction is a first direction corresponding to an extending direction of the cell 30. In FIG. 2, a Y direction is a second direction orthogonal to the X direction, and corresponds to a direction in which the cells 30 are arranged. In FIG. 2, a Z direction is a third direction orthogonal to the X direction and the Y direction, and corresponds to a stacking direction of units 50 described later. The X direction in FIG. 2 corresponds to the Z′ direction in FIG. 1, the Y direction in FIG. 2 corresponds to the Y′ direction in FIG. 1, and the Z direction in FIG. 2 corresponds to the X′ direction in FIG. 1.

The stacked body 12 includes units 50. Each of the units 50 includes a first cell group 60, a second cell group 62, a temperature control plate 64, and an insulating sheet 66. The unit 50 may include two types including one including the insulating sheet 66 and one not including the insulating sheet 66. Hereinafter, for convenience of description, the first cell group 60 and the second cell group 62 may be collectively referred to simply as a cell group without distinction.

Each of the first cell group 60 and the second cell group 62 includes cells 30. Each of the cells 30 is disposed to extend in the first direction (X direction in FIG. 2). That is, the central axis of the cell 30 extends in the X direction.

The first cell group 60 is configured so that cells 30 extending in a first direction are arranged in a second direction (Y direction in FIG. 2) orthogonal to the first direction. In the example of FIG. 2, six cells 30 arranged in the Y direction are illustrated as the first cell group 60. However, the number of cells 30 constituting the first cell group 60 may be plural, and may be equal to or less than 5 or equal to or more than 7.

The second cell group 62 is a cell group configured separately from the first cell group 60, and is configured so that cells 30 extending in the first direction are arranged in a second direction (Y direction in FIG. 2) orthogonal to the first direction. The direction in which the cells 30 constituting the second cell group 62 are arranged is the same as the direction in which the cells 30 constituting the first cell group 60 are arranged. Hereinafter, for convenience of description, the direction in which the cells 30 constituting the cell group are arranged may be referred to as a parallel direction.

In the example of FIG. 2, six cells 30 arranged in the Y direction are illustrated as the second cell group 62. However, the number of cells 30 constituting the second cell group 62 may be plural, and may be equal to or less than 5 or equal to or more than 7. The number of cells 30 constituting the second cell group 62 is assumed to be the same as the number of cells 30 constituting the first cell group 60, but may be different from the number of cells 30 constituting the first cell group 60.

The temperature control plate 64 is disposed between the first cell group 60 and the second cell group 62. The temperature control plate 64 is formed in a wave plate shape. The temperature control plate 64 is disposed so that a longitudinal direction corresponding to a traveling direction of the wave in the temperature control plate 64 is the same direction as the parallel direction of the cells 30 of the cell group.

The first cell group 60 is coupled to a first surface of two surfaces of the temperature control plate 64 via an adhesive. Each of the cells 30 of the first cell group 60 is accommodated in a valley portion formed on the first surface of the temperature control plate 64. The second cell group 62 is coupled to a second surface of the two surfaces of the temperature control plate 64 via an adhesive. Each of the cells 30 of the second cell group 62 is accommodated in a valley portion formed on the second surface of the temperature control plate 64.

Although not illustrated, a flow path through which a heat medium can flow is formed inside the temperature control plate 64. The temperature control plate 64 performs heat exchange between the heat medium flowing through the internal flow path and the first cell group 60 and the second cell group 62. By this heat exchange, the temperatures of the first cell group 60 and the second cell group 62 are adjusted.

The unit 50 is formed by bonding at least the first cell group 60 to the first surface of the temperature control plate 64 and bonding the second cell group 62 to the second surface of the temperature control plate 64.

The units 50 are stacked in the third direction (Z direction in FIG. 2) orthogonal to the extending direction (first direction) of the cells 30 and the parallel direction (second direction) of the cells 30. That is, the third direction is a stacking direction in which the units 50 are stacked. When the units 50 are stacked, the first cell group 60 and the second cell group 62 are alternately arranged along the stacking direction.

The stacked body 12 is formed by stacking the units 50 with the insulating sheet 66 interposed therebetween. The insulating sheet 66 is formed in a sheet shape by an insulator. The insulating sheet 66 is positioned between the first cell group 60 of one unit 50 of the two adjacent units 50 and the second cell group 62 of the other unit 50. The insulating sheet 66 prevents cell groups adjacent in the stacking direction from coming into contact with each other.

The insulating sheet 66 is bonded to at least one of two cell groups sandwiching the insulating sheet 66 via an adhesive. The insulating sheet 66 may be bonded to a portion of at least one of the first cell group 60 or the second cell group 62 of the unit 50 opposite to the temperature control plate 64.

### Method for Manufacturing Battery Module

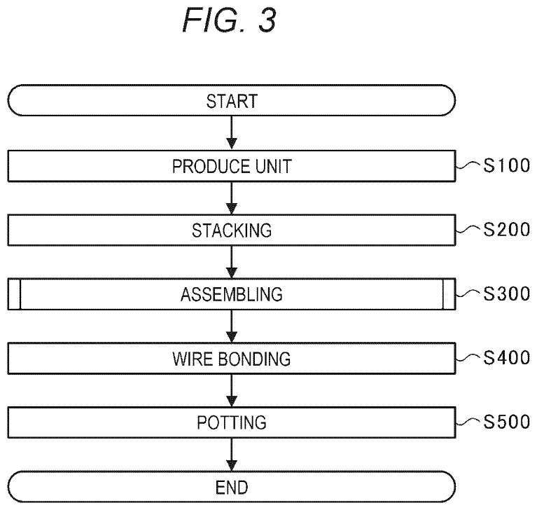

FIG. 3 is a flowchart illustrating a method for manufacturing the battery module 1 according to the embodiment. As illustrated in FIG. 3, the method for manufacturing the battery module 1 includes a unit producing step S100, a stacking step S200, an assembling step S300, a wire bonding step S400, and a potting step S500. Each step of the method for manufacturing the battery module 1 may be performed by a manufacturing machine, may be performed by a person, or may be performed by cooperation of the manufacturing machine and the person.

In the unit producing step S100, a unit 50 including the first cell group 60, the second cell group 62, and the temperature control plate 64 is produced. For example, in the unit producing step S100, the first cell group 60 is bonded to the first surface of the temperature control plate 64 via an adhesive, and the second cell group 62 is bonded to the second surface of the temperature control plate 64 via an adhesive. In addition, in the unit producing step S100, for example, the insulating sheet 66 may be bonded to a portion of the second cell group 62 on a side opposite to the temperature control plate 64 via an adhesive.

In the stacking step S200, the units 50 thus produced are stacked with the insulating sheet 66 interposed therebetween to form the stacked body 12 (see FIG. 2).

In the assembling step S300, the bus bar module 14 and the produced stacked body 12 are assembled to at least some members constituting the case 10. The assembling step S300 will be described in detail later.

In the wire bonding step S400, the electrodes of the cells 30 and the bus bars 42 are coupled by the wires 44.

In the potting step S500, potting of filling the inside of the case 10 in which the stacked body 12 and the bus bar module 14 are accommodated with a filler is performed. The potting step S500 is performed in a posture in which the upper cover 20 is positioned below the stacked body 12 and the bus bar module 14 is positioned above the stacked body 12, that is, a posture in which the upper and lower sides of FIG. 1 are reversed. In the potting step S500, a fluid filler is injected into the case 10 from the bus bar module 14 side so that the gap of the stacked body 12 is filled with the filler.

In the potting step S500, the filler is cured when a predetermined time elapses under a predetermined condition after the filler is injected. The predetermined conditions and the predetermined time vary depending on the type and characteristics of the filler. By curing the filler injected into the case 10, the performance of fixing the position of the stacked body 12 inside the case 10 is improved, and structural characteristics, electrical characteristics, and environmental characteristics of the battery module 1 can be improved.

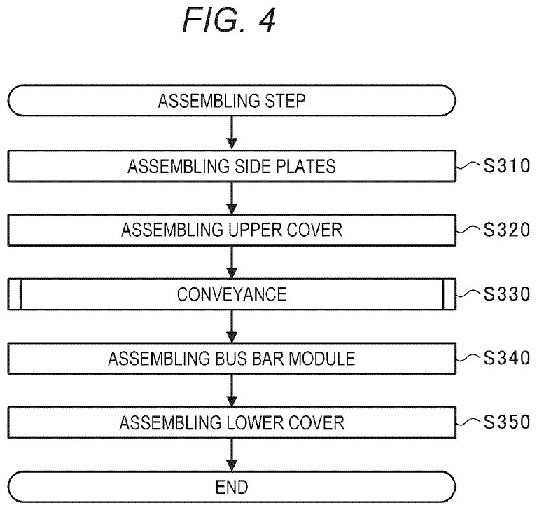

FIG. 4 is a flowchart illustrating a flow of the assembling step S300. As illustrated in FIG. 4, the assembling step S300 includes a side plate assembling step S310, an upper cover assembling step S320, a conveyance step S330, a bus bar module assembling step S340, and a lower cover assembling step S350. Each step of the assembling step may be performed by a manufacturing machine, may be performed by a person, or may be performed by cooperation of the manufacturing machine and the person.

In the side plate assembling step S310, the side plates 22 are bonded to both side surfaces of the stacked body 12 in the third direction (Z direction in FIG. 2, that is, the stacking direction of the units 50) via the adhesive.

In the upper cover assembling step S320, the upper cover 20 is bonded to the first end surface of each cell 30 of the stacked body 12 in the first direction (X direction in FIG. 2) via the adhesive. The first end surface of the cell 30 is, for example, one of two end surfaces in the first direction on which the electrode is not provided, in other words, an end surface opposite to end surfaces on which the electrodes are provided.

In the conveyance step S330, the semi-finished product in which the side plate 22 and the upper cover 20 are assembled to the stacked body 12 is conveyed to the workplace of the bus bar module assembling step S340.

In the bus bar module assembling step S340, the bus bar module 14 is assembled to the conveyed semi-finished product. For example, the bus bar module 14 is fixed to the side plate 22 so that the bus bars 42 are arranged in the vicinity of the electrodes of the cells 30 of the stacked body 12.

In the lower cover assembling step S350, the lower cover 24 is assembled to the semi-finished product to which the bus bar module 14 is assembled. For example, the lower cover 24 is fixed to the side plate 22 so that the lower cover 24 is disposed on the side opposite to the stacked body 12 with respect to the bus bar module 14.

Note that the lower cover 24 may be permanently fixed to the bus bar module 14. In this case, the lower cover assembling step S350 may be substantially included in the bus bar module assembling step S340.

In addition, the lower cover assembling step S350 is not limited to the mode executed in the assembling step S300, and may be executed, for example, after the wire bonding step S400 or after the potting step S500.

Here, it takes a predetermined time according to the type and characteristics of the adhesive until the adhesive for bonding the side plate 22 and the like is dried, that is, until the bonding is completed. Therefore, for example, when the semi-finished product is conveyed to the work place where the bus bar module 14 is assembled before the adhesive for bonding the side plate 22 is dried, the side plate 22 may be peeled off from the stacked body. On the other hand, for example, if the semi-finished product is conveyed to the work place where the bus bar module 14 is assembled after waiting for the completion of the bonding of the side plate 22, the manufacturing time becomes unnecessarily long.

Therefore, in the method for manufacturing the battery module 1 of the embodiment, while the side plate 22 is pressed toward the stacked body 12, the semi-finished product is conveyed to the work place where the bus bar module 14 is assembled, and the pressing of the side plate 22 is maintained until the bonding of the side plate 22 with the adhesive is completed.

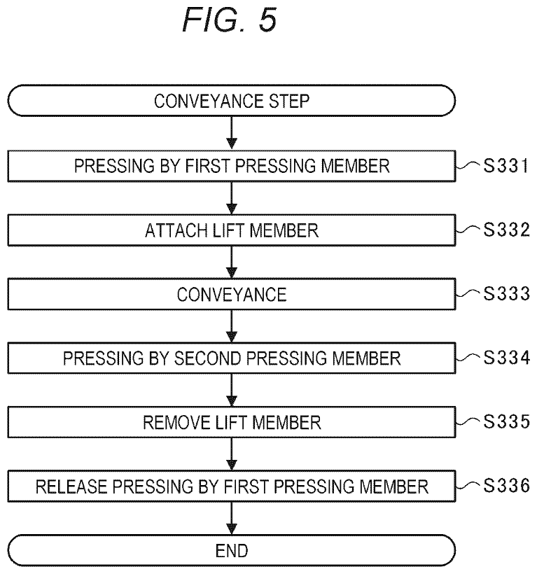

FIG. 5 is a flowchart for describing the flow of the conveyance step S330. Each step of the conveyance step S330 may be performed by a manufacturing machine, may be performed by a person, or may be performed by cooperation of the manufacturing machine and the person. Hereinafter, the semi-finished product being manufactured as a target of the conveyance step S330 may be referred to as a target semi-finished product. The target semi-finished product includes at least the stacked body 12 and the side plate 22.

In the conveyance step S330, first, the side plate 22 is pressed toward the stacked body 12 side by a first pressing member to be described later (S331). Next, a lift member to be described later is attached to the target semi-finished product (S332). Next, while the side plate 22 is pressed toward the stacked body side by the first pressing member, the target semi-finished product is conveyed to the work place where the bus bar module 14 is assembled by the lift member (S333).

Next, in the work place where the bus bar module 14 is assembled, in a state where the side plate 22 is pressed toward the stacked body 12 side by the first pressing member, the side plate 22 is pressed toward the stacked body 12 side by a second pressing member to be described later (S334). Next, the lift member is removed from the target semi-finished product in a state where the side plate 22 is pressed toward the stacked body 12 side by the first pressing member and the second pressing member (S335). Next, while the pressing of the side plate 22 by the second pressing member is maintained, the pressing of the side plate 22 by the first pressing member is released (S336).

In this manner, the side plate 22 is pressed by the first pressing member during the conveyance of the target semi-finished product, and the side plate 22 is pressed by the second pressing member after the conveyance of the target semi-finished product, and the pressing of the side plate 22 is maintained before and after the conveyance.

Note that, in FIG. 5, the pressing of the side plate 22 by the first pressing member is released after the lift member is removed from the target semi-finished product. However, after the pressing of the side plate 22 by the first pressing member is released, the lift member may be removed from the target semi-finished product.

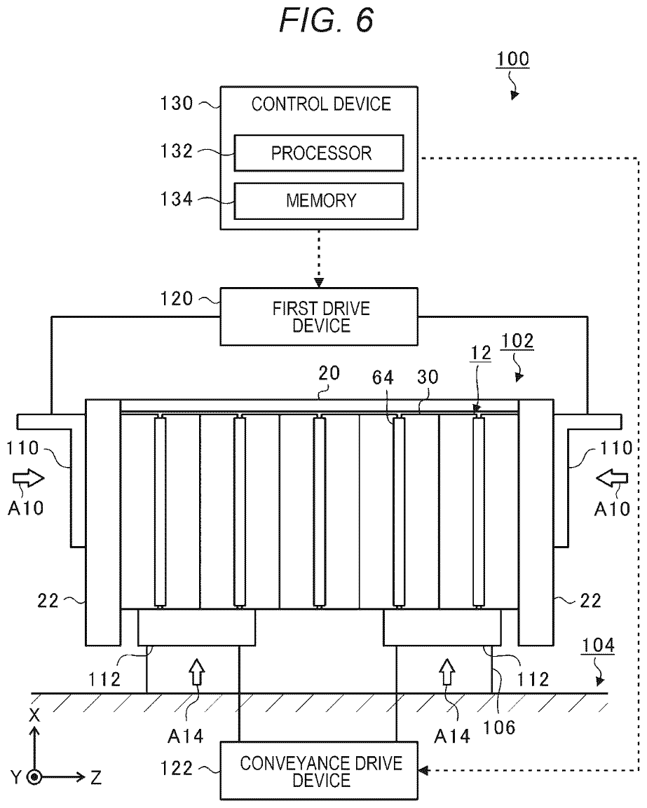

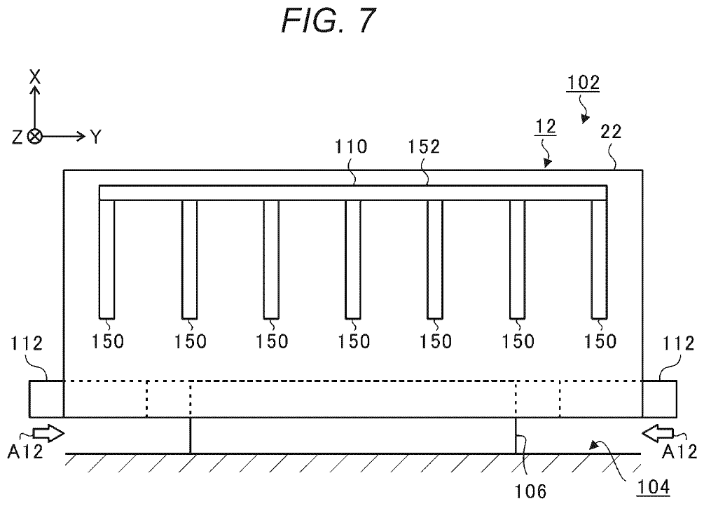

FIG. 6 is a schematic view illustrating an example of the conveyance step S330. FIG. 6 illustrates an example of a conveyance apparatus 100 that implements the conveyance step S330. FIG. 7 is a side view of a target semi-finished product 102 as viewed from the side in the conveyance step S330. FIGS. 6 and 7 illustrate a state before the target semi-finished product 102 is conveyed, that is, a state where the target semi-finished product 102 is located in a work place 104 where the side plate 22 and the upper cover 20 are assembled. In the work place 104, the target semi-finished product 102 may be placed on a predetermined work base 106.

As illustrated in FIG. 6, the conveyance apparatus 100 includes a first pressing member 110, a lift member 112, a first drive device 120, a conveyance drive device 122, and a control device 130.

A pair of first pressing members 110 is provided with the stacked body 12 and the side plates 22 interposed therebetween. Each of the first pressing members 110 is brought into contact with a surface of the side plate 22 on a side opposite to the stacked body 12.

As illustrated in FIG. 7, the first pressing member 110 includes first claws 150 and a first coupling bar 152. The first pressing member 110 is formed in a comb shape by the first claws 150 and the first coupling bar 152.

More specifically, each of the first claws 150 extends in the first direction (X direction in FIG. 7). The first claws 150 are arranged in parallel in the second direction (Y direction in FIG. 7). The first claws 150 are arranged at approximately equal intervals with a predetermined interval between adjacent first claws 150. The first claws 150 are brought into contact with the surface of the side plate 22, and can support the side plate 22.

The upper end of each of the first claws 150 in the longitudinal direction is coupled to the first coupling bar 152. The first coupling bar 152 couples the first claws 150.

As illustrated in FIG. 6, the lift member 112 is disposed below the target semi-finished product 102, for example below the stacked body 12. The lift member 112 is, for example, formed in a plate shape with a planar upper surface, and can lift and convey the target semi-finished product 102. Multiple lift members 112 may be provided in the third direction (Z direction in FIG. 6). In addition, as illustrated in FIG. 7, the lift members 112 may be arranged at both ends in the second direction (Y direction in FIG. 7) of the target semi-finished product 102.

The first drive device 120 can operate the first pressing member 110 under the control of the control device 130. For example, the first drive device 120 can cause the first claws 150 of the first pressing member 110 to approach or separate from the side plate 22. The first drive device 120 can press the first pressing member 110 in contact with the surface of the side plate 22 opposite to the stacked body 12 toward the stacked body 12 side as indicated by outlined arrows A10 in FIG. 6. That is, the first drive device 120 can press the side plate 22 from both side surfaces of the stacked body 12 toward the center by the pair of first pressing members 110.

The conveyance drive device 122 can move the lift member 112 in any direction of the vertical up-down direction and the horizontal direction under the control of the control device 130. For example, the conveyance drive device 122 can insert the lift member 112 into the space on the lower side of the stacked body 12 as indicated by outlined arrows A12 in FIG. 7. In addition, the conveyance drive device 122 can extract the lift member 112 from the space on the lower side of the stacked body 12. Further, as indicated by outlined arrows A14 in FIG. 6, the conveyance drive device 122 can lift the target semi-finished product 102 via the lift member 112 by moving the lift member 112 disposed below the target semi-finished product 102 vertically upward. Furthermore, the conveyance drive device 122 can convey the target semi-finished product 102 to any position by moving the lift member 112 in the horizontal direction while lifting the target semi-finished product 102 with the lift member 112.

The control device 130 includes one or more processors 132 and one or more memories 134 coupled to the processor 132. The memory 134 includes a ROM in which a program and the like are stored and a RAM as a work area. The processor 132 executes various types of processing in cooperation with the program included in the memory 134.

The control device 130 can control the first drive device 120 and the conveyance drive device 122 by the processor 132 executing the program. For example, the control device 130 can execute pressing of the side plate 22 by the first pressing member 110 by controlling the first drive device 120. The control device 130 can execute the conveyance of the target semi-finished product 102 by the lift member 112 by controlling the conveyance drive device 122.

In addition, the control device 130 may interlock the control of the first drive device 120 with the control of the conveyance drive device 122. For example, the control device 130 may move the first pressing member 110 in accordance with the conveyance operation of the target semi-finished product 102 by the lift member 112. Thus, the pressing of the side plate 22 by the first pressing member 110 can be appropriately maintained during the movement of the target semi-finished product 102 by the lift member 112.

As described above, in the method for manufacturing the battery module 1 of the embodiment, the side plate 22 is pressed toward the stacked body 12 side by the first pressing member 110 during the conveyance of the target semi-finished product 102 in the conveyance step S330. Therefore, in the method for manufacturing the battery module 1 of the embodiment, for example, even if the target semi-finished product 102 is conveyed before the adhesive for bonding the side plate 22 is dried, the side plate 22 can be prevented from being peeled off from the stacked body 12.

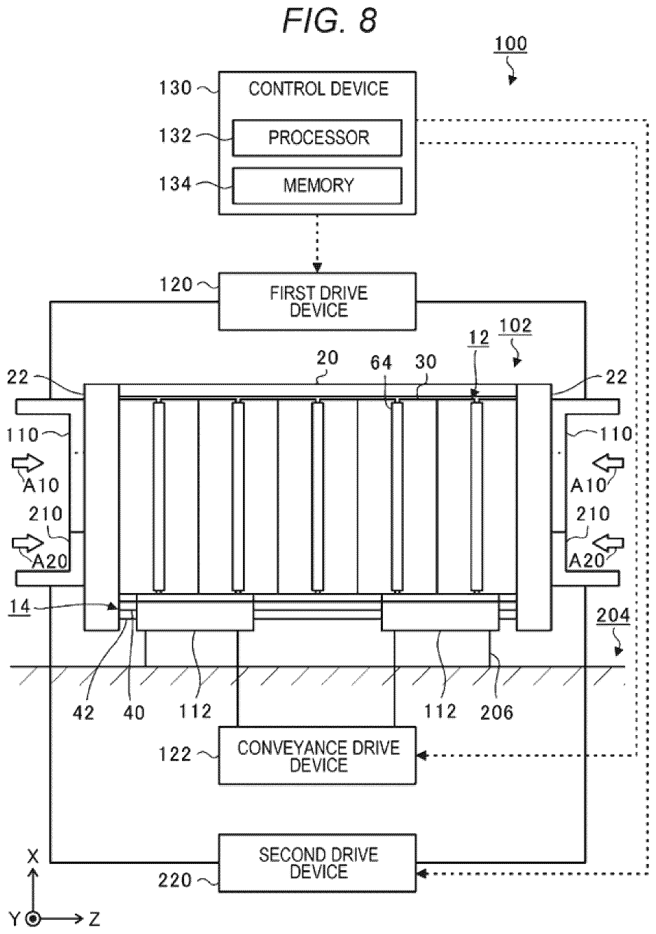

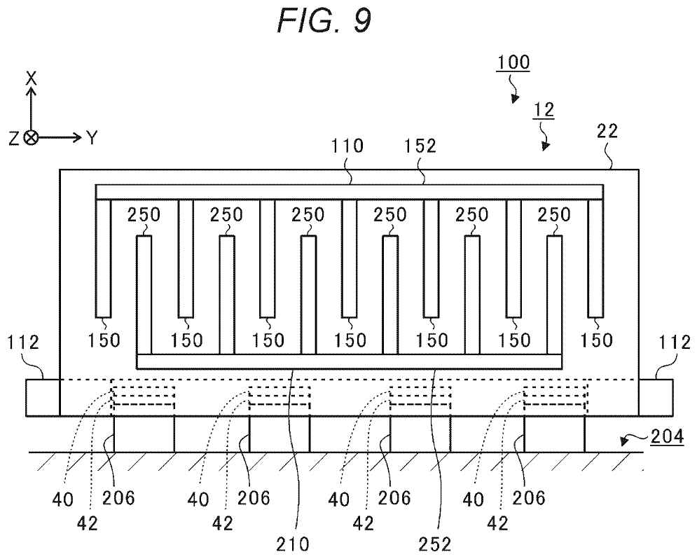

FIG. 8 is a schematic view illustrating an example of a state after conveyance in the conveyance step S330. FIG. 9 is a side view of the target semi-finished product 102 as viewed from the side after the conveyance in the conveyance step S330. FIGS. 8 and 9 illustrate a state after the target semi-finished product 102 is conveyed, that is, a state where the target semi-finished product 102 is located in the work place 204 where the bus bar module 14 is assembled.

In the work place 204, one or more work bases 206 are arranged. A bus bar module 14 is disposed on the work bases 206. The bus bar module 14 is disposed, for example, so that the bus bar plate 40 is located on the relatively upper side and the bus bar 42 is located on the relatively lower side.

The target semi-finished product 102 conveyed in the conveyance step S330 is disposed so that the stacked body 12 is positioned above the bus bar module 14.

As illustrated in FIG. 8, the conveyance apparatus 100 includes a second pressing member 210 and a second drive device 220. The second pressing member 210 and the second drive device 220 are provided, for example, in the work place 204 after the conveyance of the target semi-finished product 102.

A pair of second pressing members 210 is provided with the stacked body 12 and the side plates 22 interposed therebetween. Each of the second pressing members 210 is brought into contact with a surface of the side plate 22 on a side opposite to the stacked body 12. In other words, the second pressing member 210 contacts the same surface of the side plate 22 as the surface which the first pressing member 110 contacts.

As illustrated in FIG. 9, the second pressing member 210 includes second claws 250 and a second coupling bar 252. The second pressing member 210 is formed in a comb shape by the second claws 250 and the second coupling bar 252.

More specifically, each of the second claws 250 extends in the first direction (X direction in FIG. 7). The second claws 250 are arranged in parallel in the second direction (Y direction in FIG. 7). The second claws 250 are arranged at approximately equal intervals with a predetermined interval between the adjacent second claws 250. The second claws 250 are brought into contact with the surface of the side plate 22, and can support the side plate 22.

A lower end portion of each of the second claws 250 in the longitudinal direction is coupled to the second coupling bar 252. The second coupling bar 252 couples the second claws 250.

The first claws 150 and the second claws 250 are alternately arranged. For example, an interval between adjacent first claws 150 is wider than widths of the second claws 250 in the second direction (Y direction in FIG. 7). The second claw 250 is positioned between adjacent first claws 150. Similarly, the interval between the adjacent second claws 250 is wider than the width of the first claws 150 in the second direction (Y direction in FIG. 7). The first claws 150 are located between the adjacent second claws 250. The first claws 150 and the second claws 250 are not in contact with each other.

The second drive device 220 can operate the second pressing member 210 under the control of the control device 130. For example, the second drive device 220 can bring the second claws 250 of the first pressing member close to or away from the side plate 22. The second drive device 220 can press the second pressing member 210 in contact with the surface of the side plate 22 on the side opposite to the stacked body 12 toward the stacked body 12 side as indicated by outlined arrows A20 in FIG. 8. In other words, the second drive device 220 can press the second pressing member 210 in the same direction as the pressing direction of the first pressing member 110. That is, similarly to the pair of first pressing members 110, the second drive device 220 can press the side plate 22 from both side surfaces of the stacked body 12 toward the center by the pair of second pressing members 210.

The control device 130 can control the second drive device 220 by the processor 132 executing the program. For example, the control device 130 can execute pressing of the side plate 22 by the second pressing member 210 by controlling the second drive device 220.

As illustrated in FIG. 8, when the target semi-finished product 102 is conveyed to the work place 204, the control device 130 brings the second pressing member 210 into contact with the side plate 22 while maintaining the pressing of the side plate 22 by the first pressing member 110 as indicated by outlined arrows A10. Then, as indicated by the outlined arrows A20, the control device 130 presses the side plate 22 of the target semi-finished product 102 conveyed to the work place 204 toward the stacked body 12 side by the second pressing member 210.

The control device 130 removes the lift member 112 from the target semi-finished product 102 in a state where the pressing of the side plate 22 by the first pressing member 110 and the second pressing member 210 is maintained.

Further, the control device 130 releases the pressing of the side plate 22 by the first pressing member 110 in a state where the pressing of the side plate 22 by the second pressing member 210 is maintained. That is, the control device 130 separates the first pressing member 110 from the side plate 22 while maintaining the pressing of the side plate 22 by the second pressing member 210.

Thus, in the method for manufacturing the battery module 1 of the embodiment, the pressing of the side plate 22 is maintained from the time of conveying the target semi-finished product 102 to after the conveyance of the target semi-finished product 102. Therefore, in the method for manufacturing the battery module 1 of the embodiment, it is possible to more appropriately prevent the side plate 22 from being peeled off from the stacked body 12.

Note that the control device 130 may maintain the pressing of the side plate 22 by the second pressing member 210 during the execution of the bus bar module assembling step S340.

Further, here, an example in which the target semi-finished product 102 is conveyed to the work place 204 of the bus bar module assembling step S340 has been described. However, the method for manufacturing the battery module 1 of the embodiment is not limited to the mode in which the target semi-finished product 102 is conveyed to the work place 204 of the bus bar module assembling step S340, and may be a mode in which the target semi-finished product 102 is conveyed to a work place of a predetermined subsequent step. That is, the subsequent step of the conveyance step S330 is not limited to the bus bar module assembling step S340, and may be various steps.

As described above, the battery module 1 of the embodiment includes: the stacked body 12 including the units 50 stacked in the third direction and each including the first cell group 60 and the second cell group 62 in which the cells 30 extending in the first direction are arranged in the second direction orthogonal to the first direction, and the temperature control plate 64 disposed between the first cell group 60 and the second cell group 62 and extending in the second direction, and the side plate 22 bonded to a side surface of the stacked body 12 in the third direction. The method for manufacturing the battery module 1 of the embodiment includes bonding the side surface of the stacked body 12 and the side plate 22 via an adhesive. The method for manufacturing the battery module 1 of the embodiment includes conveying a semi-finished product (for example, the target semi-finished product 102) including the stacked body 12 and the side plate 22 to the work place 204 in a predetermined subsequent step (for example, the bus bar module assembling step S340) while pressing the side plate 22 toward the side of the stacked body 12 by the first pressing member 110. The method for manufacturing the battery module 1 of the embodiment includes pressing the side plate 22 of the semi-finished product conveyed to the work place 204 toward the side of the stacked body 12 by the second pressing member 210 disposed in the work place 204. The method for manufacturing the battery module 1 of the embodiment includes releasing the pressing of the side plate 22 by the first pressing member 110 in a state where the pressing of the side plate 22 by the second pressing member 210 is maintained.

Thus, in the method for manufacturing the battery module 1 of the embodiment, the side plate 22 is pressed toward the stacked body 12 side by the first pressing member 110 during the conveyance of the target semi-finished product 102 in the conveyance step S330. Therefore, in the method for manufacturing the battery module 1 of the embodiment, for example, even if the target semi-finished product 102 is conveyed before the adhesive for bonding the side plate 22 is dried, the side plate 22 can be prevented from being peeled off from the stacked body 12. Further, in the method for manufacturing the battery module 1 of the embodiment, the pressing of the side plate 22 is maintained from the time of conveying the target semi-finished product 102 to after the conveyance of the target semi-finished product 102. Therefore, in the method for manufacturing the battery module 1 of the embodiment, it is possible to more appropriately prevent the side plate 22 from being peeled off from the stacked body 12. Further, in the method for manufacturing the battery module 1 of the embodiment, since the pressing of the side plate 22 is maintained, it is not necessary to wait for the completion of the bonding of the side plate 22 when the target semi-finished product 102 is conveyed to the work place 204. Thus, in the method for manufacturing the battery module 1 of the embodiment, the manufacturing time can be shortened.

Therefore, in the method for manufacturing the battery module 1 of the embodiment, the side plate 22 can be appropriately adhered to the stacked body 12.

Further, in the method for manufacturing the battery module 1 of the embodiment, the first pressing member 110 includes the first claws 150 arranged in parallel in the second direction and capable of supporting the side plate 22. The second pressing member 210 includes second claws 250 arranged in parallel in the second direction and capable of supporting the side plate 22. The first claws 150 and the second claws 250 are alternately arranged.

Thus, in the method for manufacturing the battery module 1 of the embodiment, the side plate 22 can be appropriately pressed by the second pressing member 210 while the pressing of the side plate 22 by the first pressing member 110 is maintained. In addition, in the method for manufacturing the battery module 1 of the embodiment, it is possible to appropriately release the pressing of the side plate 22 by the first pressing member 110 in a state where the pressing of the side plate 22 by the second pressing member 210 is maintained.

Note that the first pressing member 110 and the second pressing member 210 are not limited to the illustrated modes, and may have various modes capable of pressing the side plate 22.

Further, in the method for manufacturing the battery module 1 of the embodiment, conveying the semi-finished product to the work place 204 includes lifting and conveying the semi-finished product by the lift member 112 disposed on the lower side of the semi-finished product.

Thus, in the method for manufacturing the battery module 1 of the embodiment, it is possible to prevent the semi-finished product from falling during conveyance, and it is possible to appropriately convey the semi-finished product.

Note that the lift member 112 may be omitted.

Although the embodiment of the disclosure has been described above with reference to the accompanying drawings, it goes without saying that the disclosure is not limited to such an embodiment. It will be apparent to those skilled in the art that various changes or modifications can be conceived within the scope described in the claims, and it is understood that these naturally belong to the technical scope of the disclosure.

1. A method for manufacturing a battery module comprising: a stacked body including units stacked in a third direction and each including a first cell group and a second cell group in which cells extending in a first direction are arranged in a second direction orthogonal to the first direction, and a temperature control plate disposed between the first cell group and the second cell group and extending in the second direction; and a side plate bonded to a side surface of the stacked body in the third direction, the method comprising:
bonding a side surface of the stacked body and the side plate via an adhesive;
conveying a semi-finished product including the stacked body and the side plate to a work place in a predetermined subsequent step while pressing the side plate toward a side of the stacked body by a first pressing member;
pressing the side plate of the semi-finished product conveyed to the work place toward a side of the stacked body by a second pressing member disposed in the work place; and
releasing the pressing of the side plate by the first pressing member in a state where the pressing of the side plate by the second pressing member is maintained.

2. The method for manufacturing the battery module according to claim 1, wherein
the first pressing member includes first claws arranged in parallel in the second direction and capable of supporting the side plate,
the second pressing member includes second claws arranged in parallel in the second direction and capable of supporting the side plate, and
the first claws and the second claws are alternately arranged.

3. The method for manufacturing the battery module according to claim 1, wherein
the conveying the semi-finished product to the work place includes lifting and conveying the semi-finished product by a lift member disposed on a lower side of the semi-finished product.
